(19) United States
(12) Patent Application Publication
(10) Pub. No.: US 2018/0030779 A1
(43) Pub. Date: Feb. 1, 2018

(54) CLOSING ELEMENT FOR ROLLER SHUTTER AND MOVABLE WALL FOR ROLLER SHUTTER COMPRISING THE CLOSING ELEMENT

(71) Applicant: Masinara S.p.A., Valsamoggia (Bologna) (IT)

(72) Inventor: Alessandro RONCHETTI, Castel d'Aiano (Bologna) (IT)

(21) Appl. No.: 15/727,871

(22) Filed: Oct. 9, 2017

Related U.S. Application Data
(62) Division of application No. 15/012,389, filed on Feb. 1, 2016, now Pat. No. 9,803,420.

(30) Foreign Application Priority Data
Feb. 6, 2015 (IT) BO2015A000047

(51) Int. Cl. E06B 9/15; E06B 9/06; E06B 9/17

(52) U.S. Cl. CPC E06B 9/15; E06B 9/17; E06B 9/0638; E06B 2009/1566; E06B 2009/1505

(57) ABSTRACT

A closing element for roller shutters comprising a central portion designed to be arranged, in use, according to a closing plane of an access opening of a room to at least partly close the access opening, and at least two connecting portions located on opposite edges of the central portion, each of which designed for connection of the closing element with at least one other closing element. Each connecting portion extends about a respective axis and defines a cavity for housing a connecting bar. The connecting portion has an open profile so that the cavity is accessible transversely to the axis.

This application claims priority to Italian Patent Application BO2015A000047 filed Feb. 6, 2015, the entirety of which is incorporated by reference herein.

### BACKGROUND OF THE INVENTION

This invention relates to a closing element for a roller shutter as well as a movable wall for a roller shutter comprising the closing element.

More specifically, the closing elements for a roller shutter to which reference is made are those used in the field of elements for closing accesses or rooms (such as, for example, garages, shops, workshops, etc.) for making closing systems, including roller shutters.

Roller shutters usually comprise:

a shaft positioned at the upper end of the opening of the access to be closed and fixed to a pair of plates are associated with (connected) to the corresponding vertical wall delimiting the opening of the access;

a movable “sheet” (or wall) associated with the shaft and which can be wound about the shaft, which may, if required, slide in lateral guides positioned on the vertical walls delimiting the opening of the access;

a motor for driving the shaft, to open and close the access opening.

The movable sheet usually comprises a succession of closing elements of elongate shape, and generally positioned in a horizontal direction, and a series of longitudinal bars which are inserted one at a time into respective connecting sockets made along the longitudinal edges of the plate-like closing elements.

In this way it is possible to slide each bar inside the sockets, aligned with each other, of pairs of consecutive plate-like closing elements. By repeating this procedure it is possible to obtain a longitudinal link and plate-like closing elements which define the movable sheet for the roller shutter.

Moreover, there are solutions wherein each closing element may be in turn defined by a series of closing elements aligned in a horizontal direction, in which the closing elements of each row are all connected, on each side, to a respective common connecting bar.

In this configuration, connecting rods may also be interposed between one closing element and the next having at the relative ends ring-shaped passages to be inserted on the longitudinal bars.

In order to fit the movable sheet the operator must make a link according to a precise predetermined pattern, by inserting in a sliding fashion each plate-like closing element and/or each connecting mechanism on the basis of a sequential assembly order proceeding by rows.

An error during installation, or a change during the operations, may result in the need to remove the link and repeat the installation operations from the beginning.

Once installed, in the case of maintenance, if a plate-like closing element or a connecting mechanism must be replaced it is necessary to withdraw at least the row in which piece to be replaced is located and then refit the row by reinserting the pieces removed; these operations, as well as being laborious, require considerable time.

Moreover, each installation of existing roller shutters are made with movable sheets only having longitudinal bars and connecting bars. These solutions leave the shutter equipped with a mainly open part, leaving the space behind on view.

If for any reason a user wanted the sheets of these shutters to be fitted with plate-like closing elements, for example to prevent a third party from throwing objects or inserting their hands through the shutter from an environment outside the access to one inside, the movable sheet would need to be removed completely to be able to insert a plate-like closing element of the type described above between one connecting rod mechanism and the next.

### SUMMARY OF THE INVENTION

In this context, the technical purpose which forms the basis of this invention is to provide a closing element for a roller shutter and a sheet for a roller shutter comprising the closing element which overcomes one or more of the above mentioned drawbacks of the prior art.

More specifically, the aim of this invention is to provide a closing element for a roller shutter which is structurally simple and easy to install.

A further aim of this invention is to provide a closing element for roller shutters which is versatile and which can be used to improve existing closing systems.

The technical purpose indicated and the aims specified are substantially achieved by a closing element of a roller shutter comprising the technical features described in one or more of the appended claims.

More specifically, this invention comprises a closing element for roller shutters comprising a central portion designed to be arranged, in use, according to a closing plane of an access opening of a room to at least partly close the access opening, and at least two connecting portions located on opposite edges of the central portion, each of which designed for connection of the closing element with at least one other closing element.

Each connecting portion extends about a respective axis and defines a cavity for housing a connecting bar.

The connecting portion has an open profile in such a way that the cavity is accessible transversely to the axis.

This invention also relates to a movable sheet for a roller shutter which is easily modular using closing elements which can be quickly fitted and removed and which can be adapted in a simple and fast fashion to the requirements of the user.

More specifically, this invention comprises a movable sheet for a roller shutter comprising a plurality of a closing elements for a roller shutter according to this invention and a plurality of connecting bars.

Each connecting bars is engaged permanently inside at least one connecting portion of a first closing element and at least one connecting portion of a second closing element to define a hinged connection between the first and second closing element.

The connecting portions of the first and second closing element are extractable from the connecting bar along a direction of extraction transversal to the axis defined by the connecting portions.

The dependent claims, incorporated herein for reference, relate to different embodiments of the invention.

### BRIEF DESCRIPTION OF THE DRAWINGS

Further features and advantages of the invention are more apparent in the detailed description below, with reference to a preferred, non-limiting, embodiment of a closing element of a roller shutter and a sheet for a roller shutter as illustrated in the accompanying drawings, in which:

FIG. 1 is a schematic perspective view of a movable sheet for a roller shutter according to a first embodiment of this invention,

FIG. 2 is a schematic perspective view of a portion of a movable sheet of FIG. 1 during a fitting/removal step,

FIG. 3 is a schematic perspective view of a closing element for a roller shutter according to this invention,

FIG. 4 is a schematic side view of the closing element of FIG. 3 according to the viewing direction K,

FIG. 5 is a schematic perspective view of a movable sheet for a roller shutter according to a second embodiment of this invention,

FIG. 6 is a schematic perspective view of a portion of a movable sheet of FIG. 5 during a fitting/removal step, and

FIGS. 7A and 7B are two schematic perspective views, respectively, of a stiffening element for a roller shutter in an assembled configuration and in a non-assembled configuration.

### DESCRIPTION OF THE PREFERRED EMBODIMENTS

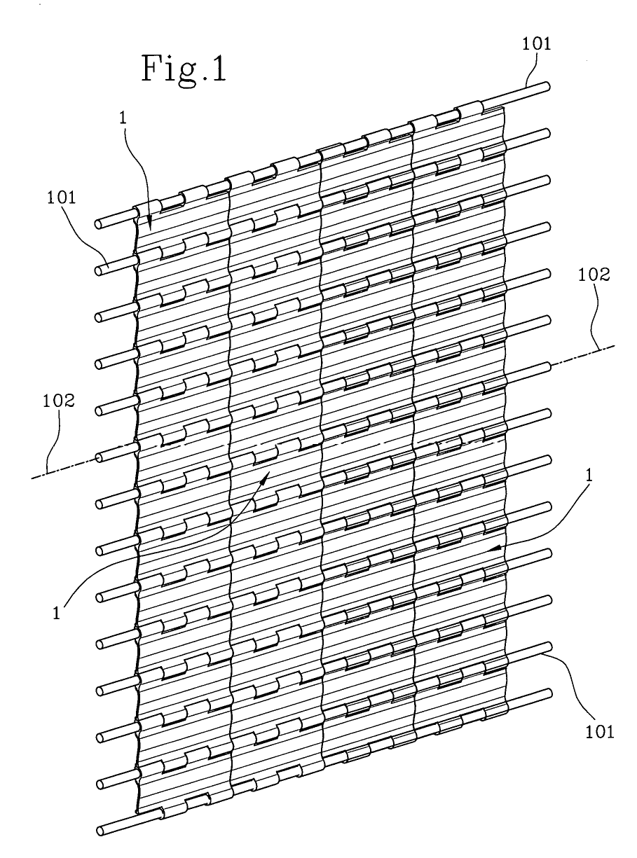

A sheet or movable wall (the words sheet or wall will be used below without distinction) for a roller shutter made according to the invention is indicated in its entirety in FIGS. 1, 2, 5, 6 with the numeral 100.

The movable sheet 100 is of the type designed to be wound on a shaft, positioned at the upper end of an access opening to be closed, and supported in use by at least a corresponding wall of the room delimiting the access opening.

The movable sheet 100 can be wound and unwound about the shaft to open and close, respectively, the access opening along a generally vertical closing plane.

Preferably, the movable sheet 100 is at least partly flexible for allowing the winding about the shaft.

The movement of the movable sheet 100 may be carried out using movement means of known type.

For example the movement means may be of a manual type (the user manually moves the movable sheet 100 from the bottom upwards or vice versa to open or close the access opening) or may comprise a motor unit for the automatic movement of the movable sheet 100 for unwinding and winding.

Preferably, the roller shutter comprises lateral guides, positioned vertically on the vertical walls at the intrados of the access opening, to guide the sliding of the lateral ends of the movable sheet 100 in the guides themselves during the winding and unwinding of the movable sheet 100.

It should be noted that the term “closing plane” refers to the plane delimited by the intrados of an access opening of a room, through which the user intends to allow or prevent access to the room.

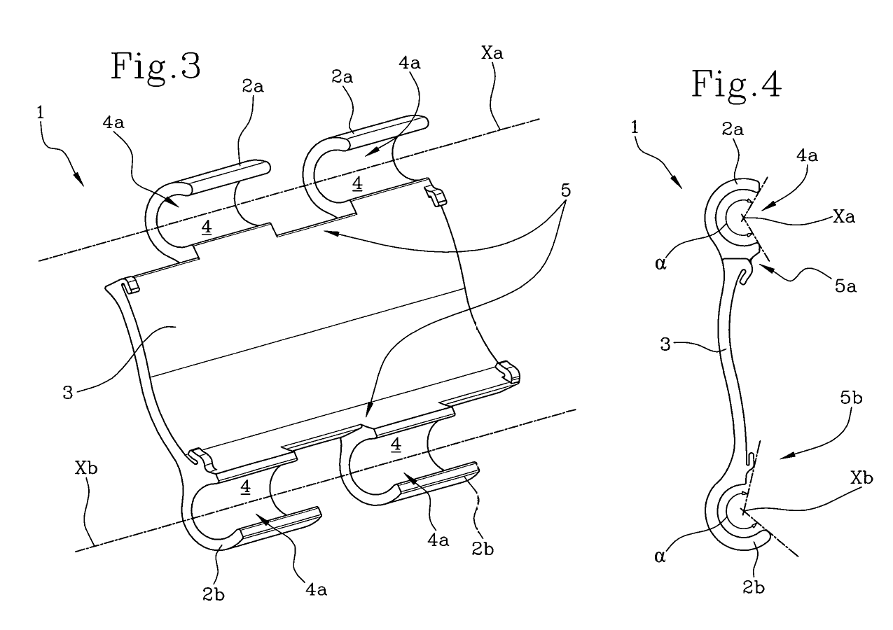

With reference to FIG. 3, the movable sheet 100 for a roller shutter according to this invention comprises a plurality of closing elements 1 and a plurality of connecting bars 101 engaged to the closing elements 1, articulated to each other to define a complex configuration of the roller type.

Preferably, the connecting bars 101 are of tubular shape, preferably circular in cross section and still more preferably made of metal.

Preferably, the free ends of the connecting bar 101 are configured to slide inside the lateral guides (not illustrated) of the roller shutter.

Preferably, the connecting bar 101 is positioned in use inside the closing plane in such a way that a main axis of extension 102 of the connecting bar 101 lies in the closing plane.

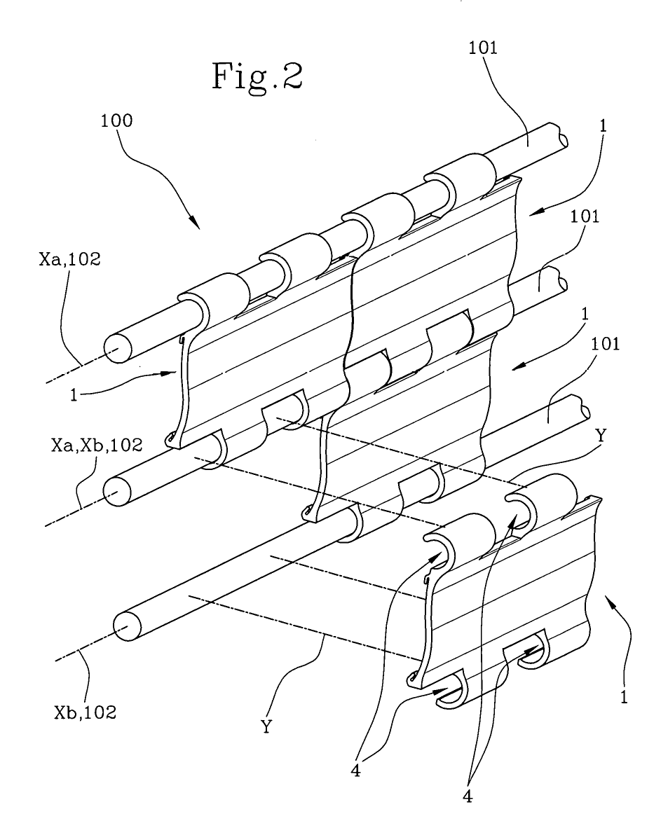

With reference to the first embodiment of FIGS. 1 and 2, the sheet comprises a plurality of closing elements 1 positioned preferably on horizontal rows and positioned side by side horizontally on each row, and a plurality of connecting bars 101, wherein each connecting bar 101 is engaged simultaneously with a plurality of first closing elements 1 on one side (above), and a plurality of second closing elements 1 on the other side (below) to define a hinged connection between the first and second closing elements 1.

FIGS. 3 and 4 illustrate in detail the embodiment of the closing elements 1 according to this invention.

The closing element 1 comprises a central portion 3 and at least two connecting portions 2a, 2b positioned on opposite edges 5a, 5b of the central portion 3. Each connecting portion 2a, 2b is designed for connecting with at least another closing element 1 using a connecting bar 101.

The central portion 3 is designed to be positioned, in use, according to the closing plane of the access opening and preferably lies flat or substantially flat in such a way that the joining of a succession of closing elements 1 defines an extension to the roller sheet.

Each connecting portion 2 extends about a respective axis ‘Xa’, ‘Xb’ which are preferably rectilinear and preferably parallel to the closing plane.

Each connecting portion 2 defines a cavity 4 for housing the connecting bar 101.

With reference to the connecting portion (positioned above in use) labelled 2a, it should be noted that the portion is preferably locked (with interference) to the connecting bar 101.

For this reason, preferably, the internal diameter of the cavity 4 of the portion 2a is sized to allow a locking (with interference) of the connecting bar in the cavity 4.

With reference to the connecting portion (positioned below in use) labelled 2b, it should be noted that the portion is preferably coupled with clearance to the connecting bar 101.

For this reason, preferably, the internal diameter of the cavity 4 of the portion 2b is sized to allow a free coupling (with clearance) of the connecting bar 101 in the cavity 4.

It should be noted that the inside diameters of the cavity 4 of the first and second portions are different to each other.

Preferably, the two connecting portions 2a, 2b are shaped in reciprocally compatible manner so that they can align the axes ‘Xa’, ‘Xb’ of the connecting portions 2a, 2b of two identical adjacent closing elements 1, in a coupling configuration.

To accomplish this, the two connecting portions 2a, 2b are arranged on the closing element 1 in a position axially offset along the axes ‘Xa’, ‘Xb’.

Advantageously, each connecting portion 2a, 2b at the cavity 4 has an open profile in such a way as to be accessible transversely to the axis ‘Xa’, ‘Xb’.

In other words, the connecting portion 2a, 2b has a circumferential zone of discontinuity 4a defining the zone of transversal access to the cavity 4.

As the profile of the connecting portion 2a, 2b, is open transversely to the axis X, it allows the closing element 1 to be applied on the connecting bar 101 simply by fitting the cavity 4 transversely on the connecting bar 101, at the circumferential zone of discontinuity 4a of the connecting portion 2a, 2b.

Thanks to this invention, the cavity 4 is designed to receive the connecting bar 101 both transversely and longitudinally relative to the axis ‘Xa’, ‘Xb’.

With reference to FIG. 1, each connecting bar 101 and the respective first and second closing elements 1 to which it is connected can be separated from each other along a direction of extraction “Y” substantially transversal to the axis ‘Xa’, ‘Xb’ defined by the connecting portions 2a, 2b.

In other words, each closing element 1 can be mounted on and removed from any connecting bar 101 simply by fitting the connecting portion 2 on the outer lateral surface of the connecting bar 101, thus without the need to remove the connecting bar 101 and insert each closing element 1 from a lateral free end of the connecting bar 101 along the axis ‘Xa’, ‘Xb’.

Advantageously, if the user needs to replace one closing element 1 with another, or simply if it is necessary to remove it for routine maintenance and then refit it, it will not be necessary to remove the adjacent closing elements 1 but simply remove only the closing element 1 in question, thus saving considerably in terms of time needed for the intervention.

Preferably, the cavity 4 of the connecting portion 2 is designed to receive the connecting bar 101 in such a way that the main axis of extension 102 of the connecting bar 101 is positioned, in use, coincident with the axis ‘Xa’, ‘Xb’ of the connecting portion 2a, 2b of the closing element 1.

Preferably, moreover, the closing elements 1 are rotatably coupled to the respective connecting bars 101 in such a way that the connecting bars 101 form the bending zones of the sheet 100.

In this configuration, the cavity 4 is defined by a receiving surface defined by a cylindrical surface part inside the connecting portion 2.

With reference to FIG. 4, preferably the cylindrical surface part of the connecting portion 2a, 2b extends about the axis ‘Xa’, ‘Xb’ for an angle α of between 100° and 180° calculated in the cavity 4 between the ends of the circumferential zone of discontinuity 4a.

Preferably, the connecting portion 2a, 2b is elastically deformable in such a way as to allow a coupling and uncoupling in a snap-on fashion with the connecting bar 101.

In the embodiment of the closing element 1 illustrated in FIGS. 3 and 4, there are two connecting portions 2a, 2b on each edge 5a, 5b, having axes ‘Xa’, ‘Xb’ coincident; however, the number of connecting portions 2a, 2b could be greater than on the basis of the dimensional characteristics of the closing element 1.

Preferably, the connecting portions 2a positioned on an edge 5a of a closing element 1 are positioned in a complementary fashion to the connecting portions 2b of the other edge 5b of the closing element 1, in such a way that by coupling together identical closing elements 1 there is a snap-on connection between the connecting portions 2a, 2b of the two connecting elements 1, in particular each connecting portion 2a being positioned in the space formed between the connecting portions 2b of the other closing element 1.

Advantageously, in this way the closing element 1 may also be fitted upside down further simplifying the installation operations; however it is also possible to make different reasons textures and patterns in the link which makes up the movable sheet 100.

In this regard, it should be noted that the element 1 can advantageously be made of different colors and textures and with different materials to produce customizable graphical patterns and effects according to the requirements of the user.

Thanks to this invention, the user can obtain a movable sheet 100 which is able to improve the appearance of the relative access opening (for example, shop windows).

Moreover, it is possible to apply on the central portion 3 of the closing element logos and brands to make the movable sheet 100 even more customized.

Preferably, the closing element 1 is configured as a single-block element, however in embodiments not illustrated in the accompanying drawings it is possible that the connecting portion 2 is engaged to the central portion 3 by interposing a fixing element which rotatably couples the two components.

Preferably, the closing element 1 or the central portion 3 are made of plastic material.

Preferably, the closing element 1 or the central portion 3 are transparent; this aspect may be advantageous for particular applications in which the user wants to make the environment inside the access opening open to view (for example a display window) during a closed configuration of the movable sheet 100 in which access is prevented (for example during closing times).

According to the embodiment of the closing element 1 illustrated in the drawings, the central portion 3 preferably has a convex cross section towards the closing plane.

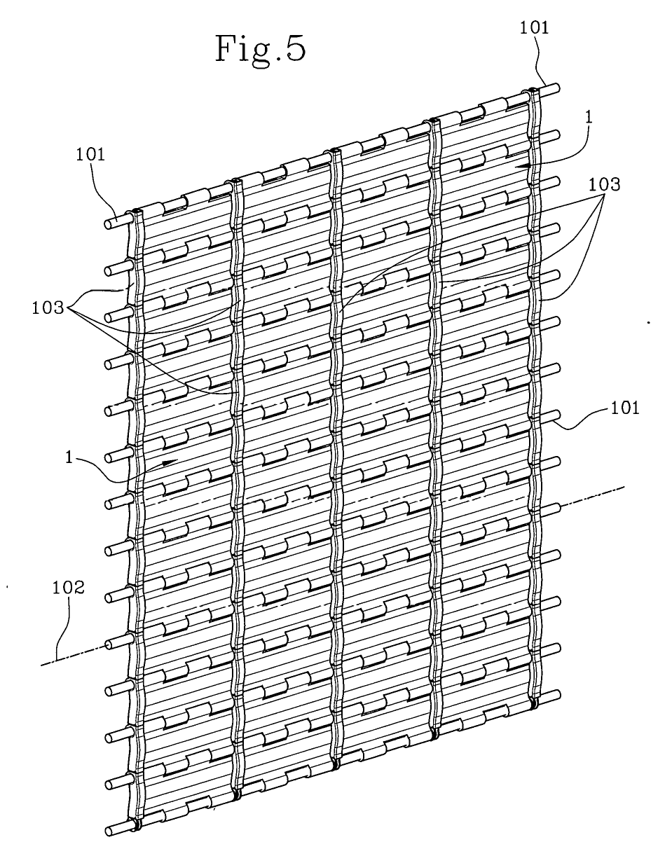

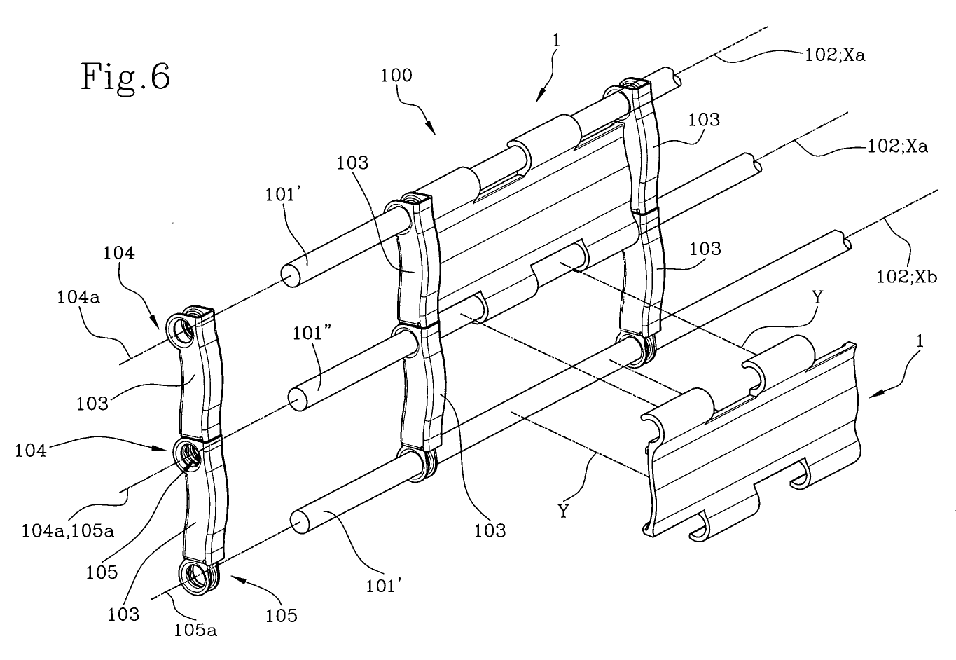

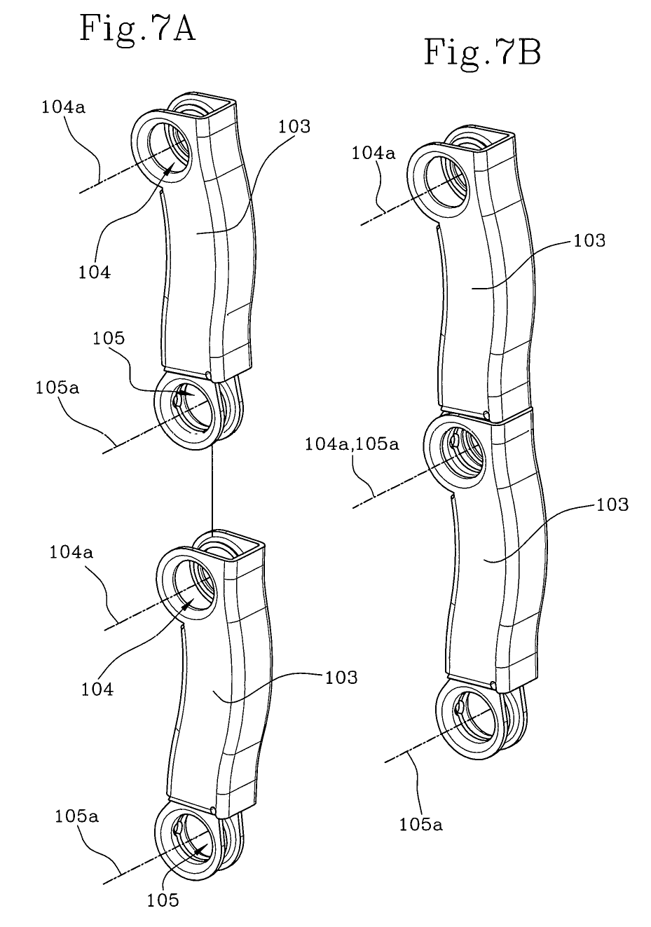

With reference to a second embodiment of the movable sheet 100 illustrated in FIGS. 5 and 6, the movable sheet 100 comprises at least one stiffening element 103, as better illustrated in detail in FIGS. 7A and 7B, having a first seat 104 and a second seat 105 designed to receive rotatably, respectively, a first connecting bar 101′ and a second connecting bar 101″ of the movable sheet 100 adjacent to each other.

Preferably, the seats 104, 105 have a circular cross-section in such a way that, if the connecting bars 101 have a circular cross-section, the first connecting bar 101′ can rotate about a first axis of rotation 104a of the first seat 104 and that the second connecting bar 101″ can rotate about a second axis of rotation 105a of the second cavity 105.

As illustrated in FIGS. 5 and 6 relative to the second embodiment of the movable sheet 100, the stiffening element 103 is positioned alongside at least one closing element 1 in order to stiffen the movable sheet 100 and define a more resistant structure of the roller shutter.

According to a possible embodiment of the stiffening element 103, not illustrated in the drawings, the first seat 104 and/or the second seat 105 define an open hook, in such a way that each stiffening element 103 can be fitted transversely on at least one of the connecting bars 101 (preferably but not necessarily in a snap-on fashion).

In this way it is possible to speed up the operations for fitting the movable sheet 100; moreover, it is possible to equip already existing movable sheets 100 with stiffening elements 103, without necessarily having to insert the seats 104, 105 from the ends of the connecting bars 101, but simply applying them transversely to the axis of extension 102 of the connecting bars 101.

As illustrated in FIGS. 7A, 7B, preferably the first seat 104 of a first stiffening element 103 can be inserted inside the second seat 105 of a second stiffening element 103, so that the two seats 104, 105 can be aligned on a same connecting bar 101, thus defining a hinged coupling between the stiffening elements 103.

According to this invention it is also possible to install a roller shutter having a movable sheet 100 defined by a plurality of connecting bars 101 and by a plurality of stiffening elements 103, in such a way as to make an open link structure which can be advantageously closed when necessary.

To increase the safety and/or the resistance of roller shutters equipped with a movable sheet 100 according to this invention, preferably each stiffening element 103 comprises fixing means, not illustrated in the accompanying drawings, positioned at least at one of the seats 104, 105 to achieve a retaining stable of the respective connecting bar 101 in the seat 104, 105 preventing a mutual sliding between the connecting bar 101 and the stiffening element 103.

For example, the fixing means can be screws or more preferably deformable fixing rings (open).

Advantageously, the deformable fixing rings are applicable to the respective stiffening elements 103 with considerable ease.

The present invention achieves the preset aims, overcoming the disadvantages of the prior art.

Advantageously, the closing element 1 according to this invention, unlike the prior art which comprises a laborious assembly of the closing elements on the longitudinal bars by a lateral insertion of the closing elements from a free end of the bar of the sockets (closed cavities) which, thanks to the presence of the connecting portions 2a, 2b with an open profile is characterized by a high degree of accessibility which allows a simple and fast fitting and removal during the installation or maintenance steps of the movable sheets 100.

The movable sheet 100 according to this invention is easily modular shaft thanks to the presence of simple and easily installable closing elements 1.

The closing element 1 is also advantageously adaptable to existing roller shutters, for example of the open mesh type wherein horizontal bars and vertical connecting rods delimit openings to allow the visibility of the environment separated by the shutter.

1.-14. (canceled)

15. A movable closing wall for closing roller shutters, comprising:
a plurality of connecting bars;
a plurality of closing elements for closing roller shutters, each of the plurality of closing elements comprising:
a central portion adapted to at least partly close an access opening of a room, in use, according to a closing plane of the access opening of the room,
at least a first connecting portion and a second connecting portion;
wherein:
the first connecting portion of each closing element is arranged on a first edge of the central portion of the same closing element and extends along a first axis;
the second connecting portion of each closing element is arranged on a second edge of the central portion of the same closing element and extends along a second axis;
the first edge and second edge of each closing element are opposite to each other;
the second axis of the second connecting portion of each closing element is parallel to the first axis of the first connecting portion of the same closing element;
each of the first connecting portion and second connecting portion of each closing element is adapted to couple with at least one further closing element and defines a respective cavity for housing a connecting bar;
each of the first connecting portion and second connecting portion of each closing element has an open profile so that the respective cavity is accessible transversely to the respective axis;
the first connecting portion and second connecting portion of each closing element are arranged in a position axially offset to each other along a direction parallel the respective axes;
the open profile of each of the first connecting portion and second connecting portion of each closing element is defined by a circumferential opening;
each of the first connecting portion and second connecting portion of each closing element extends about the respective axis by an angle ranging between 100° and 180°;
each of the first connecting portion and second connecting portion of each closing element is elastically deformable so as to allow a snap-fit coupling and uncoupling with said connecting bar transversely to the respective axis;
each connecting bar is engaged inside the first connecting portion of a first closing element and inside the second connecting portion of a second closing element to define a hinged connection between said first closing element and second closing element, each of said first connecting portion of said first closing element and second connecting portion of said second closing element being extractable from said engaged connecting bar along a direction of extraction substantially transversal to the respective axis.

16. The movable closing wall according to claim 15, wherein each cavity has a receiving surface defined by a part of a cylindrical surface.

17. The movable closing wall according to claim 15, wherein the first connecting portion and second connecting portion of each closing element define cavities with different diameters.

18. The movable closing wall according to claim 15, wherein the closing elements are rotatably coupled to the respective connecting bars.

19. The movable closing wall according to claim 15, wherein the circumferential opening has a chord length less than a diameter of the connecting bar.

20. A movable closing wall for closing roller shutters, comprising:
a plurality of connecting bars;
a plurality of closing elements for closing roller shutters, each of the plurality of closing elements comprising:
a central portion adapted to at least partly close an access opening of a room, in use, according to a closing plane of the access opening of the room,
at least a plurality of first connecting portions and a plurality of second connecting portions;
wherein:
the first connecting portions of each closing element are arranged on a first edge of the central portion of the same closing element and extend along a first axis;
the second connecting portions of each closing element are arranged on a second edge of the central portion of the same closing element and extend along a second axis;
the first edge and second edge of each closing element are opposite to each other;
the second axis of the second connecting portions of each closing element is parallel to the first axis of the first connecting portions of the same closing element;
each of the first connecting portions and each of the second connecting portions of each closing element is adapted to couple with at least one further closing element and defines a respective cavity for housing a connecting bar;
each of the first connecting portions and each of the second connecting portions of each closing element has an open profile so that the respective cavity is accessible transversely to the respective axis;
the first connecting portions of each closing element are arranged in a position axially offset, with respect to the second connecting portions of the same closing element, along a direction parallel the respective axes;
the open profile of each of the first connecting portions and of each of the second connecting portions of each closing element is defined by a circumferential opening;
each of the first connecting portions and each of the second connecting portions of each closing element extends about the respective axis by an angle ranging between 100° and 180°;
each of the first connecting portions and each of the second connecting portions of each closing element is elastically deformable so as to allow a snap-fit coupling and uncoupling with said connecting bar transversely to the respective axis;
each connecting bar is engaged inside the first connecting portions of a first closing element and inside the second connecting portions of a second closing element to define a hinged connection between said first closing element and second closing element, each of said first connecting portions of said first closing element and each of said second connecting portions of said second closing element being extractable from said engaged connecting bar along a direction of extraction substantially transversal to the respective axis;
at least one of the first connecting portions of said first closing element is positioned in a space formed between two of the second connecting portions of said second closing element.
